(19) United States
(12) Patent Application Publication
(10) Pub. No.: US 2009/0119969 A1
(43) Pub. Date: May 14, 2009

(54) FISHING POLE HOLDER

(76) Inventor: Wayne Cavanaugh, Oakdale, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/938,063

(22) Filed: Nov. 9, 2007

(51) Int. Cl. A01K 97/10

(52) U.S. Cl. 43/21.2

(57) ABSTRACT

A fishing pole holder that can be safely secured to the ground or a boat or an object such as a tackle box or cooler that contains a ground penetration spike, but can quickly and easily adjust the angle of the fishing pole, without adjusting the spike in the ground; and further this invention a notch in the holder that acts as a fishing pole locking mechanism.

### I. BACKGROUND OF THE INVENTION

A. Field of the Invention

The invention broadly relates to fishing accessories, and in particular, a fishing rod holder.

B. Prior Art

Fishing pole holders that are supported on the ground by a ground-penetrating member are well known in the art. In this respect, throughout the years, a number of innovations have been developed relating to such ground-supported fishing pole holders, and the following U.S. patents are representative of some of those innovations: U.S. Pat. Nos. 1,577,612; 2,414,358; 2,612,334; 3,339,869; and 4,658,534. More specifically, U.S. Pat. No. 1,577,612 discloses a fishing pole support having a ground-penetrating member that is unscrewed from a tubular pole-handle receiver and stored therein when the fishing pole support is not being used to support a fishing pole. It is noted that the ground-penetrating member is disassembled and stored as two independent components inside the tubular pole-handle receiver. As a result, the components of the ground-penetrating member can move and rattle inside the pole-handle receiver during storage. Such movement and rattling can be annoying. In this respect, it would be desirable if a fishing rod holder apparatus were provided such that a ground-penetrating member, when not in use, does not move or rattle inside the storage space.

U.S. Pat. No. 2,414,358 discloses a fishing rod holder apparatus that has a ground-penetrating member that is not retained inside a tubular pole-handle receiver when the ground-penetrating member is not in the ground. Such an unprotected ground-penetrating member can be dangerous. It's sharp point can cause a person to be cut or can cause articles surrounding a stored fishing rod holder apparatus to be poked or punctured. In this respect, it would be desirable if a fishing rod holder apparatus were provided that comprises a ground-penetrating member that does not poke or puncture or cut persons or articles that come into contact with it.

U.S. Pat. No. 3,339,869 discloses a fishing rod holder apparatus that includes a ground-penetrating member that is in a form of a thin, shell-like concave blade. Such a blade is relatively weak compared to a solid cylindrical spike for a ground-penetrating member. In this respect, it would be desirable if a fishing rod holder apparatus were provided that included a ground-penetrating member that is in a form of a cylindrical spike.

U.S. Pat. No. 4,658,534 discloses a fishing rod holder apparatus that includes a ground-penetrating member that is in a form of a cylindrical spike. The spike includes external threads that are screwed into a sleeve that is inserted inside a tubular pole-handle receiver. When a fishing pole handle is supported by the tubular pole-handle receiver, the fishing pole handle comes in direct contact with head portion of the spike. To prevent a fishing pole handle from being soiled by direct contact with a head of a ground-penetrating spike, it would be desirable if a fishing rod holder apparatus were provided which keeps the fishing pole handle from coming in direct contact with the ground-penetrating member. Furthermore, rather than having a sleeve that receives the ground-penetrating member from being inserted into the tubular pole-handle receiver, it would be desirable for a coupler member located between the tubular pole-handle receiver and the ground-penetrating member to be connected to an outside portion of a bottom end of the tubular pole-handle receiver. An internal sleeve takes up space that would otherwise be available to the handle of the fishing pole.

U.S. Pat. No. 6,318,017 discloses a fishing rod holder apparatus that includes a tubular handle receiver unit which includes a top receiver end and a bottom receiver end. The bottom receiver end has a bottom internal diameter. A ground penetration spike assembly is connected to the bottom receiver end and includes a spike retention member and a spike retained by the spike retention member. The spike retention member has an external member diameter which is less than the bottom internal diameter of the handle receiver unit. The handle receiver unit has a longitudinal receiver unit length. The ground penetration spike assembly has a longitudinal spike assembly length, and the receiver unit length is greater than the spike assembly length. The apparatus is used in either of two modes: a ground penetration mode in which a fishing rod handle is inserted into the handle receiver unit, whereby the fishing rod is supported; and a storage mode in which the ground penetration spike assembly is stored within the handle receiver unit. The handle receiver unit includes a tube member, and a coupler member is connected to a bottom end of the tube member. The coupler member includes an inner ring-shaped stop member located between a tube member reception portion and a spike assembly reception portion. The tube member is fitted into the tube member reception portion. The spike assembly reception portion of the coupler member is internally threaded with internal threads. A hook assembly is connected to the tube member of the handle receiver unit.

Although all of these referenced fishing rod holders contain a ground penetration spike, they each have deficiencies that the invention described herein resolves. For instance, these references fail to disclose a fishing pole holder that can quickly and easily adjust the angle of the fishing pole, without adjusting the spike in the ground. Further, the invention described herein does not rely entirely on having to place the spike into the ground to support the fishing pole, since this invention allows for placement of the holder onto a fixed object, such as an ice chest or tackle box. Further the invention described herein comprises a notch in the holder that acts as a fishing rod locking mechanism. Lastly, the invention can be made very compact, and as such can be stored in a pocket or tackle box.

It is therefore an object of the present invention to provide a new and improved fishing rod holder apparatus which has all of the advantages of the prior art and none of the disadvantages.

It is another object of the present invention to provide a new and improved fishing rod holder apparatus which may be easily and efficiently manufactured and marketed.

It is a further object of the present invention to provide a new and improved fishing rod holder apparatus which is of durable and reliable construction.

It is a further object of the present invention to provide a new and improved fishing rod holder apparatus that is compact and easily storable in clothing (pocket), ice chest, or tackle box.

An even further object of the present invention is to provide a new and improved fishing rod holder apparatus which is susceptible of a low cost of manufacture with regard to both materials and labor, and which accordingly is then susceptible of low prices of sale to the consuming public, thereby making such fishing rod holder apparatus available to the buying public.

Still yet a further object of the present invention is to provide a new and improved fishing rod holder apparatus which a ground-penetrating member, when not in use, does not move or rattle inside the storage space.

Still another object of the present invention is to provide a new and improved fishing rod holder apparatus that comprises a ground-penetrating member that does not poke or puncture or cut persons or articles that come into contact with it.

Even another object of the present invention is to provide a new and improved fishing rod holder apparatus that includes a ground-penetrating member that is in a form of a cylindrical spike.

Still a further object of the present invention is to provide a new and improved fishing rod holder apparatus which keeps a fishing pole handle from coming in direct contact with the ground-penetrating member.

Yet another object of the present invention is to provide a new and improved fishing rod holder apparatus that provides a coupler member located between the tubular support member 12 and the tubular rod holding member that allows the user to adjust the angle between the those two elements.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### II. BRIEF DESCRIPTION OF THE DRAWINGS

FIG. 1 is a perspective view of the fishing pole holder.

FIG. 2 is a perspective view of the tubular rod holder.

FIG. 3 is a perspective view of the tubular support member and the mounting bracket.

FIG. 4 is a perspective view of the spike retention housing and the spike.

FIG. 5 is a transparent side view of the spike retention housing and the spike.

FIG. 6 is side view of the tubular support unit, mounting bracket, and tubular rod holder.

FIG. 7a is a side view of the fishing pole holder attached to a tackle box or cooler.

FIG. 7b is a side view of a portion of FIG. 7a, showing the connection between the bottom end of the tubular support member and the top of the tackle box or cooler.

FIG. 8 is side view of an embodiment of the invention, along with a fishing rod being held by the invention.

### III. DETAILED DESCRIPTION OF THE INVENTION

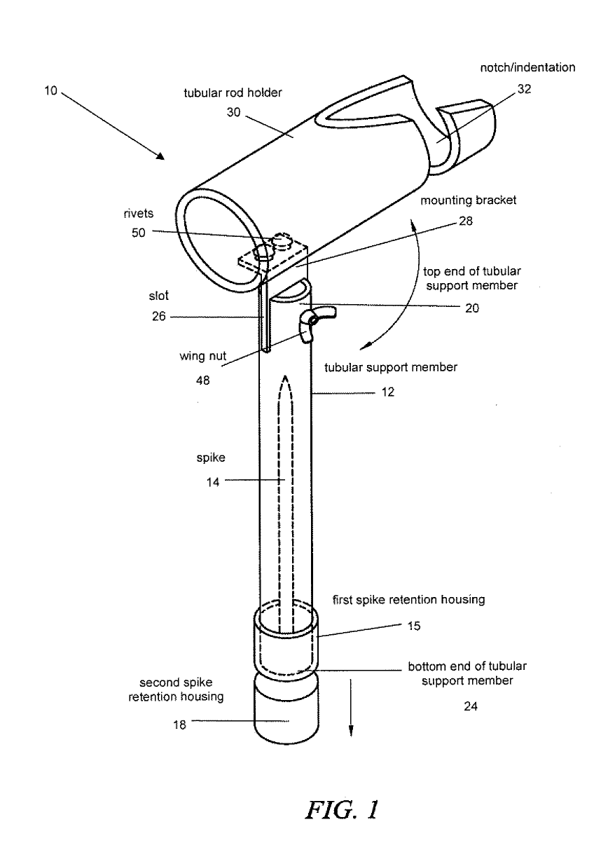

The fishing pole holder 10 according to the present invention is shown in FIG. 1. This fishing pole holder 10 includes a tubular support member 12 comprising, an elongated hollow member having a top end 20 and a bottom end 24, wherein said bottom end 24 has a bottom external diameter and a bottom internal diameter. The tubular support member 12 has a top end 20 that has a top external diameter and a top internal diameter, wherein said tubular support member 12 has a longitudinal length.

Also shown in FIGS. 4, 5, and 8 is a spike assembly comprising: a first spike retention housing 15, having an opening on one side of the housing and an internal housing diameter which is greater than said bottom external diameter of said bottom end 24 of the tubular support member 12, as well as the first spike retention member 15. This configuration will allow the user to place the bottom end 24 of the tubular support member 12 securely in the first spike retention housing 15. The spike 14 has a longitudinal spike length, and is retained by said first spike retention member 15. Since it is intended that the spike 14 can be stored within the tubular support member 12, said tubular support member 12 length should be greater than the longitudinal spike 14 length. Also shown in FIG. 1 is a second spike retention member 18, which is attached to the first spike retention member 15. When the spike 14 is placed into the ground, the bottom end of the tubular support member 24 can be placed into the second spike retention member 18.

The fishing pole holder 10 includes a spike element 14 having a pointed end and a head portion 52 located at the end opposite the pointed end. The head portion 52 may be placed into the spike retention housing 15, 18, which allows the spike 14 to be housed within the tubular support member 12, or reversed and placed into the ground. When the spike element 14 is placed into the ground, the open end of the second spike retention member 18 can hold the tubular support member 12. In a preferred embodiment, the spike element 14 is constructed of a sturdy material so that when the head 52, or spike retention housing 15, is hit with a hammer or mallet or rock, the spike 14 can be driven into ground, ice or sand.

Also shown in the drawings is a tubular rod holder 30 comprising an elongated hollow member sized such as to allow a handle 44 of a fishing rod 40 to be placed therein, as well as a notch 32, or indentation 32 along the elongated hollow member that works as a rod locking mechanism. It is anticipated that the user can place the fishing rod handle 44 into the tubular rod holder 30, then turn the rod 40 so that the support arm 46 of the fishing rod 40 can be placed into the indentation 32. This will secure the fishing rod 40 into the rod holder 30 and allow for hands free fishing, along with a quick and easy way to retrieve the fishing rod 40 from the tubular rod holder 30 when desired.

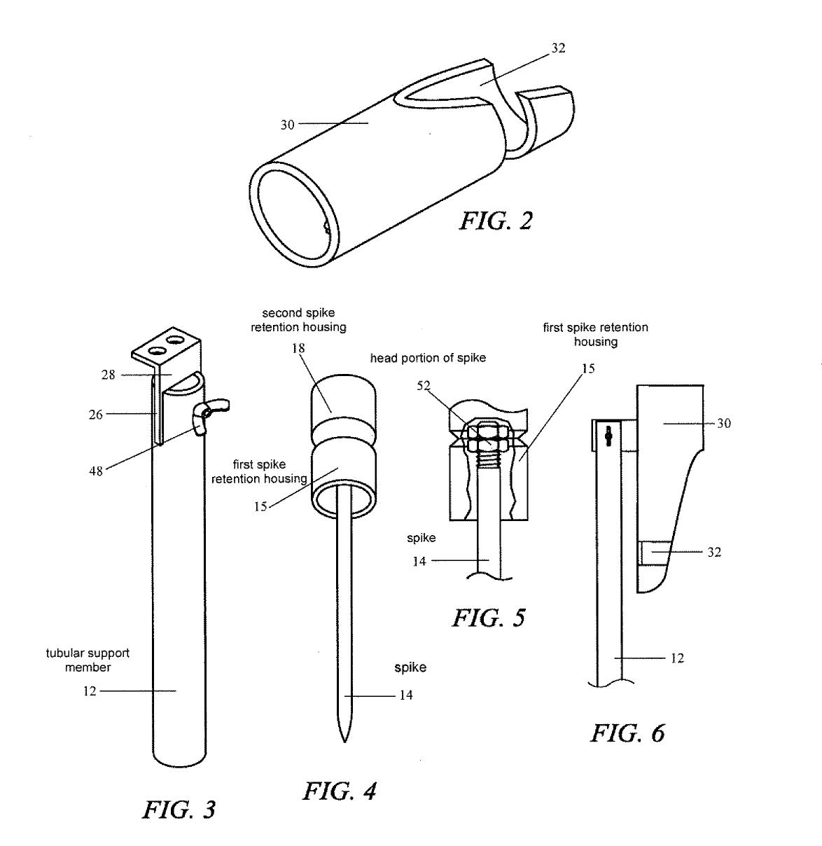

FIGS. 1, 2, 3, and 7a show a connecting means to connect the top end 20 of the tubular support member 12 to the tubular rod holder unit 30. This connection allows for an adjustable angle between the planes of the longitudinal lengths of the tubular support member 12 and the tubular rod holder 30. The connecting means comprises a means to adjust the angle between the longitudinal lengths of the tubular support member 12 and the tubular rod holder 30. The connecting means may include a mounting bracket 28 that can be attached to the top of the tubular support member 12 and the tubular rod holder 30. The connecting means may also include a slot 26 in the top 20 of the tubular support member 12, wherein said mounting bracket 28 is at least partially located within the slot 26.

The connecting means can be a mounting bracket 28 that attaches the tubular rod holder 30 to the top end 20 of the tubular support member 12. The connecting means can include a bracket 28 placed into a slot 26 located in the top 20 of the tubular support member 12. A screw can be placed through the top 20 of the tubular support member 12, through the slot 26 and mounting bracket 28, and held in place via a wing nut 48. Further, the mounting bracket 28 can attach to the tubular rod holder 30 via screws or rivets 50.

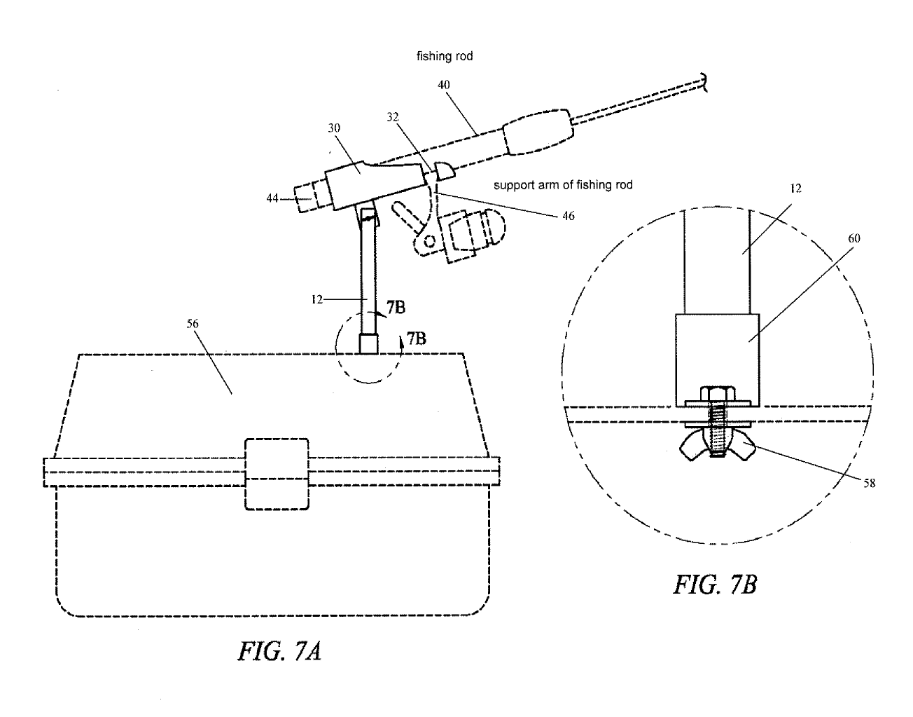

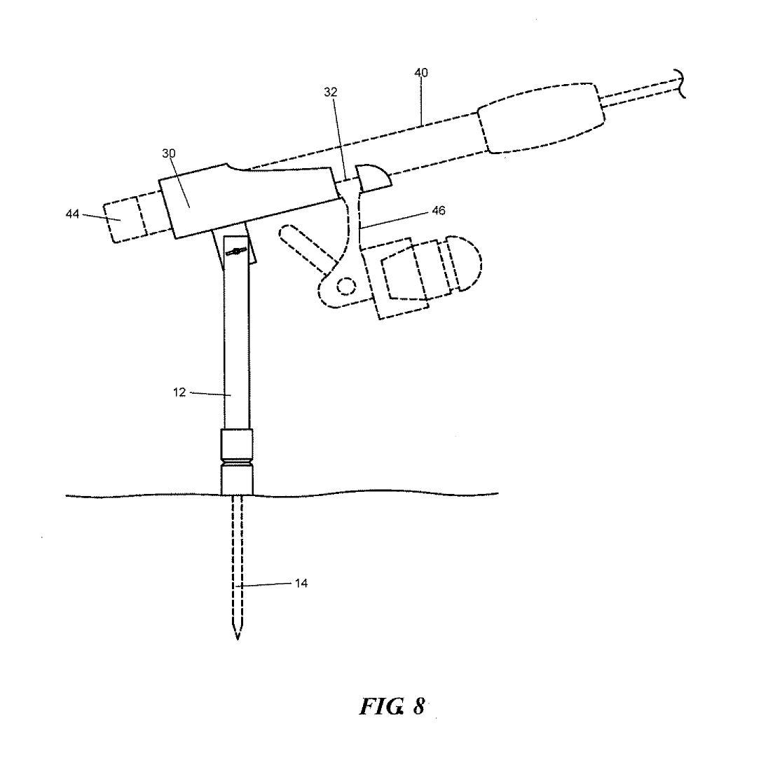

The fishing rod holder apparatus 10 is used in at least three modes: a ground-penetration mode shown in FIG. 8, a mode wherein the device is attached to a fixed object shown in FIGS. 7a and 7b; and a storage mode shown in FIG. 1. As shown in FIG. 8, the spike 14 is driven into the ground, and the fishing rod handle 44 of the fishing rod 40 is inserted into the tubular rod holder 30 and twisted such that the support arm 46 of the fishing pole 40 lodges into the notch/indentation 32 on the tubular rod holder 30. In this way, the fishing rod 40 is held in the fishing rod holder apparatus 10 of the invention.

FIG. 7b shows the connection between the bottom end 24 of the tubular support member 12 and the top of a tackle box or cooler 56. In this embodiment, a tubular support member housing 60 is attached to the cooler/tackle box 56 via a wing nut 58 and screw assembly (however other means of connecting the tubular support member housing 60 could also work). The tubular support member 12 can then be placed directly into the tubular support member housing 60 to support the fishing pole holder 10, as well as the fishing rod 40.

The components of the fishing rod holder apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

I claim:

1. A fishing rod holder apparatus, comprising:
a. a tubular support member comprising:
i. an elongated hollow member having a top end and a bottom end, wherein said bottom end has a bottom external diameter and a bottom internal diameter; and
ii. wherein said top end has a top external diameter and a top internal diameter; and
iii. wherein said tubular support member has a longitudinal length;
b. a spike assembly comprising:
i. a first spike retention housing, having an opening on one side of the housing having an internal housing diameter which is greater than said bottom external diameter of said bottom end of the tubular support member;
ii. spike retention member;
iii. a spike having a longitudinal spike length, and wherein the spike is retained by said spike retention member;
c. a tubular rod holder comprising:
i. an elongated hollow member sized such as to allow a handle of a fishing rod to be placed therein;
ii. an indentation along the elongated hollow member of a size capable of accommodating a support arm of a fishing rod; and
d. a connecting means to connect the top end of the tubular support member and the tubular rod holder unit creating an angle between the planes of the longitudinal lengths of the tubular support member and the tubular rod holder, and wherein said connecting means comprises a means to adjust the angle between the longitudinal lengths of the tubular support member and the tubular rod holder.

2. A fishing rod holder apparatus, comprising:
a. a tubular support member comprising:
i. an elongated hollow member having a top end and a bottom end, wherein said bottom end has a bottom external diameter and a bottom internal diameter; and
ii. wherein said top end has a top external diameter and a top internal diameter;
b. a tubular rod holder comprising:
i. an elongated hollow member sized such as to allow a handle of a fishing rod to be placed therein;
ii. an indentation along the elongated hollow member of a size capable of accommodating a support arm of a fishing rod;
c. a connecting means to connect the top end of the tubular support member and the tubular rod holder unit creating an angle between the planes of the longitudinal lengths of the tubular support member and the tubular rod holder, and wherein said connecting means comprises a means to adjust the angle between the longitudinal lengths of the tubular support member and the tubular rod holder; and
d. a base attachment housing, comprising:
i. an opening on one side of the housing having an internal housing diameter which is greater than said bottom external diameter of said bottom end of the tubular support member;
ii. a means of attaching the base attachment housing to a fixed object.

3. The fishing rod holder apparatus of claim 1, wherein said spike assembly further comprises a second spike retention housing attachable to said first spike retention housing wherein the second spike retention housing comprises an opening on one side of the housing having an internal housing diameter of about the same size as said opening of the first spike retention housing.

4. The fishing rod holder apparatus of claim 1 or 2, wherein said connecting means to connect the top end of the tubular support member and the tubular rod holder comprises a mounting bracket attached to the top of the tubular support member and the tubular rod holder.

5. The fishing rod holder apparatus of claim 4, further comprising a slot in the top of the tubular support member, and wherein said mounting bracket is at least partially located within the slot.

6. The fishing rod holder apparatus of claim 5, further comprising:
a. a screw located through the top end of the support member such that the end of the screw protrudes from the tubular support member; and
b. a wing nut attachable to the end of the screw.

7. The fishing rod holder apparatus of claim 2, wherein the means of attaching the base attachment housing to a fixed object comprises:
a. a tubular support member housing;
b. a threaded screw;
c. a washer; and
d. a wing nut.

8. The fishing rod holder apparatus of claim 2, wherein the means of attaching the base attachment housing to a fixed object comprises:
a. an adhesive located on the bottom of the housing.

9. The fishing rod holder apparatus of claim 1, wherein said tubular support member length is greater than said longitudinal spike length.
